(19) United States
(12) Patent Application Publication
(10) Pub. No.: US 2006/0259267 A1
(43) Pub. Date: Nov. 16, 2006

(54) Tilt calibration system for a medical imaging apparatus

(75) Inventor: Rajagopal Narayanasamy, Bangalore (IN)

Correspondence Address: INTERNATIONAL PATENT COUNSELORS, P.O. BOX 2843, SPOKANE, WA, 99220-2843, US

(73) Assignee: General Electric Company, Schenectady, NY (US)

(21) Appl. No.: 11/125,449

(22) Filed: May 10, 2005

(51) Int. Cl. G01C 17/00

(52) U.S. Cl. 702/150; 5/600; 700/302

(57) ABSTRACT

In an embodiment, a tilt calibration system for a medical imaging apparatus having a positioner axis, comprises at least one first sensor (e.g. an accelerometer), configured to determine the position of the positioner axis relative to ground, and at least one second sensor (e.g. an encoder), configured to output tilt position feedback of the positioner axis, and a processor is configured to determine a home offset in response to the position of the positioner axis relative to ground, and the tilt position feedback.

### FIELD OF THE INVENTION

This invention relates generally to tilt calibration systems, and more particularly, to a tilt angle calibration system for a positioner.

### BACKGROUND OF THE INVENTION

Typically, a positioner in a medical imaging apparatus includes mechanisms for longitudinal and lateral tilt for a patient bed, and pivot rotation for a vascular gantry. The positioner provides convenient positioning of a patient for medical imaging. One example of a positioner is a vascular gantry comprising a C-arm and a pivot axis. Examples of medical imaging apparatus include an X-ray apparatus and a vascular imaging apparatus.

Drive mechanisms for tilting the positioner require calibration for setting of a zero degree position for accurate positioning of the patient for examination. The zero degree position is often referred to the “home” position.

Generally, systems for calibrating tilt angle of the positioner e.g. a vascular positioner in a medical imaging apparatus include various procedures for determining the relative difference between the zero degree position of an axis (e.g. lateral tilt axis, longitudinal tilt axis) of the vascular positioner and a position sensor's reading corresponding to the zero degree position. The relative difference is often referred to as home offset or datum shift.

Known systems for tilt calibration of a vascular positioner e.g. patient bed include manual procedures that are followed at the time of manufacture of the table.

However, manual calibration procedures are generally cumbersome and involve multiple steps for appropriate execution by a skilled field engineer.

Furthermore, re-calibration of the tilt angle becomes necessary at the time of servicing and/or installation of the table, particularly for example, during software updates or drive chain replacement.

Thus, conventional systems do not (i) provide for an automated calibration procedure that significantly reduces manufacturing time, equipment installation and servicing time (ii) improve patient safety by providing redundant angle information and avoiding single point failure (iii) provide uniform manual panning effort between subsequent installations and (iv) significantly simplify the configuration and reduce the number of components by eliminating limit switches and accessories for calibration.

### BRIEF DESCRIPTION OF THE INVENTION

The above-mentioned shortcomings, disadvantages and problems are addressed herein, which will be understood by reading and studying the following specification.

In some embodiments, a tilt calibration system for a positioner in a medical imaging apparatus is provided, wherein the system comprises at least one first sensor configured to determine the position of at least one vascular positioner axis relative to the ground surface, at least one second sensor configured to determine the position of the at least one vascular positioner axis relative to a home position, and a processor configured to determine a home offset (datum shift) in response to the position of the positioner axis relative to the ground and the position of the positioner axis relative to the home position.

In some embodiments, a patient support table is provided, wherein the table comprises at least one tilt drive coupled to a patient support surface, a tilt position feedback device connected to the tilt drive, an accelerometer coupled to the patient bed, and a processor connected to the accelerometer and the tilt position feedback device.

In some embodiments, a patient support table comprises a first unit for determining the position of at least one tilting member relative to the ground, a second unit for determining the position of the at least one tilting member relative to a home position, and a processor for determining a home offset in response to the output of the first unit and the second unit.

Apparatus, systems and methods of varying scope are described herein. In addition to the aspects and advantages described here, further aspects and advantages will become apparent by reference to the drawings and reading the detailed description that follows.

### BRIEF DESCRIPTION OF THE DRAWINGS

FIG. 1 shows a perspective view of the patient support table according to one embodiment.

FIG. 2 is a block diagram showing an example of the circuit for tilt angle calibration according to one embodiment.

FIG. 3 shows a perspective view of the patient support table depicting the hinge and the tilt plate according to one embodiment.

FIG. 4 shows a perspective view of the patient support table, according to one embodiment.

FIG. 5 shows a block side-view of a medical imaging apparatus, according to one embodiment.

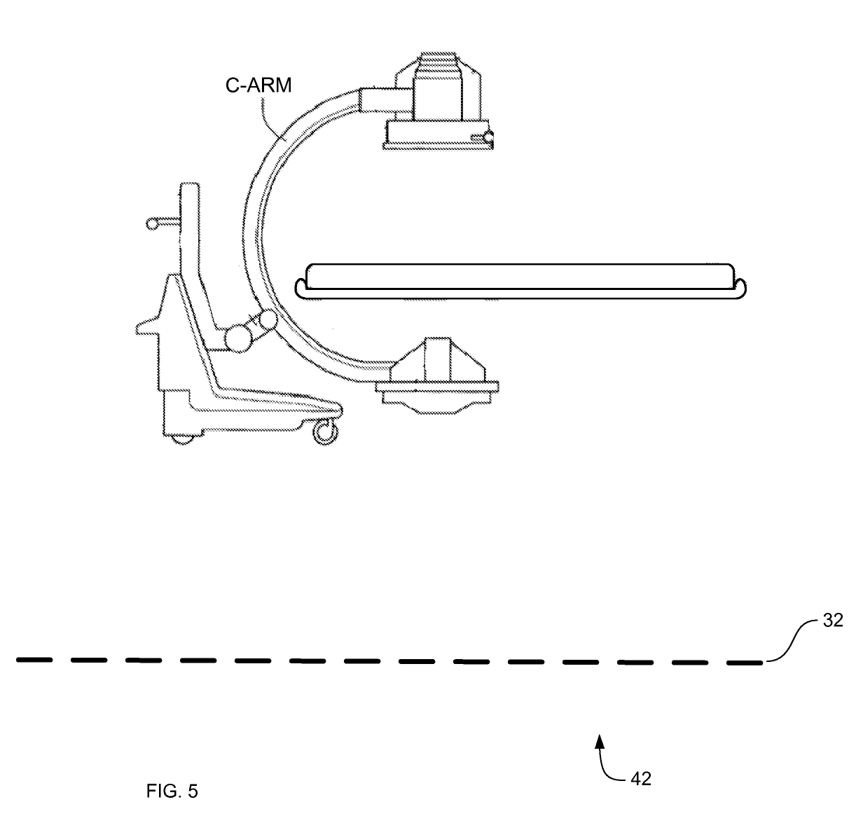

### DETAILED DESCRIPTION OF THE INVENTION

In the following description, reference is made to the accompanying drawings that form a part hereof, and in which is shown by way of illustration, specific embodiments which may be practiced. These embodiments are described in sufficient detail to enable those skilled in the art to practice the embodiments, and it is to be understood that embodiments may be utilized and that logical, mechanical, electrical and other changes may be made without departing from the scope of the embodiments. The following detailed description is, therefore not to be taken in a limiting sense.

Various embodiments provide a tilt calibration system for a positioner having a positioner axis 44 such as, a vascular positioner, e.g. a vascular gantry 42, a patient bed, in a medical imaging apparatus such as, for example, in an X-ray apparatus, vascular imaging apparatus, etc. Various specific embodiments include a patient support table in a medical imaging apparatus.

However, the embodiments are not so limited, and may be implemented in connection with other systems such as, for example, a camera, aircraft flight control systems, pallet indexing in machining center, automobile security systems, special switches, etc.

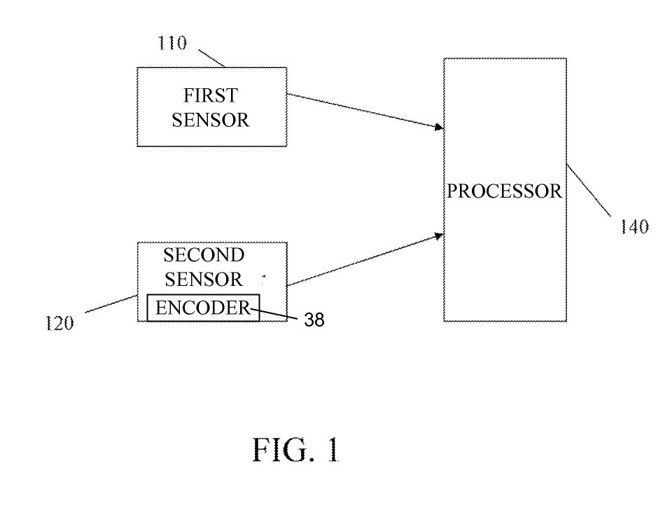

FIG. 1 shows an embodiment of a tilt calibration system for a medical imaging apparatus includes at least one first sensor 110 configured to determine the position of the positioner axis 44 relative to ground 32, at least one second sensor 120 (tilt position feedback device 30) configured to determine the position of the positioner axis 44 relative to a home position 34, and a processor 140 to determine a home offset (datum shift) in response to the position of the positioner axis 44 relative to ground 32 and the position of the positioner axis 44 relative to the home position 34.

The vascular positioner includes at least one of a patient bed and a vascular gantry 42.

For example, the vascular positioner axis 44 may include at least one of a lateral tilt axis and a longitudinal tilt axis.

In an embodiment, the first sensor 110 includes at least one of an accelerometer 60 and an inclinometer 36, wherein the accelerometer 60 has a Micro Electromechanical Systems (MEMS) configuration.

In an embodiment, the second sensor 120 includes at least one feedback device 30 such as, for example, an encoder.

For example, the encoder may include an infinite-turn type absolute position encoder or an incremental encoder.

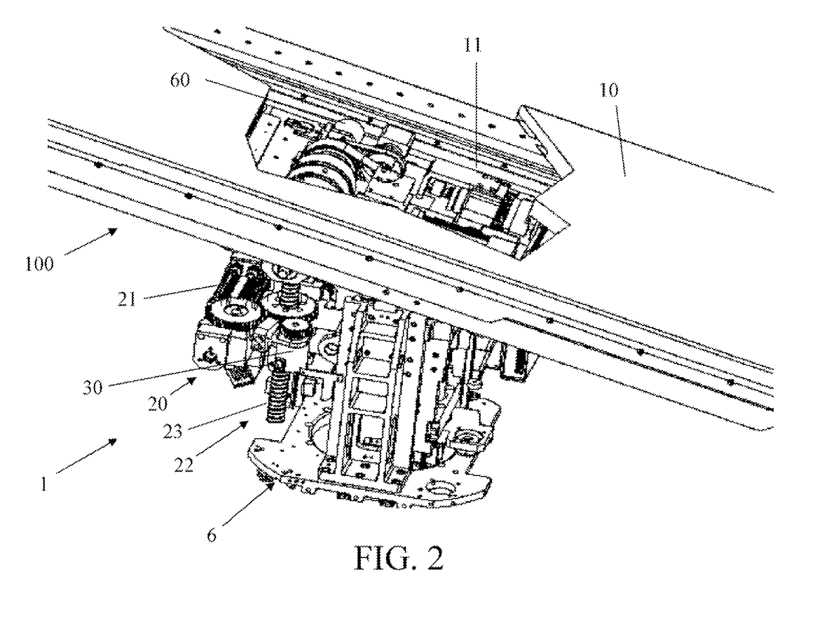

FIG. 2 shows an embodiment, wherein the patient support table 1 comprises a patient bed 100 (vascular positioner) tiltably supported over a base 6. The base is supported on the ground surface.

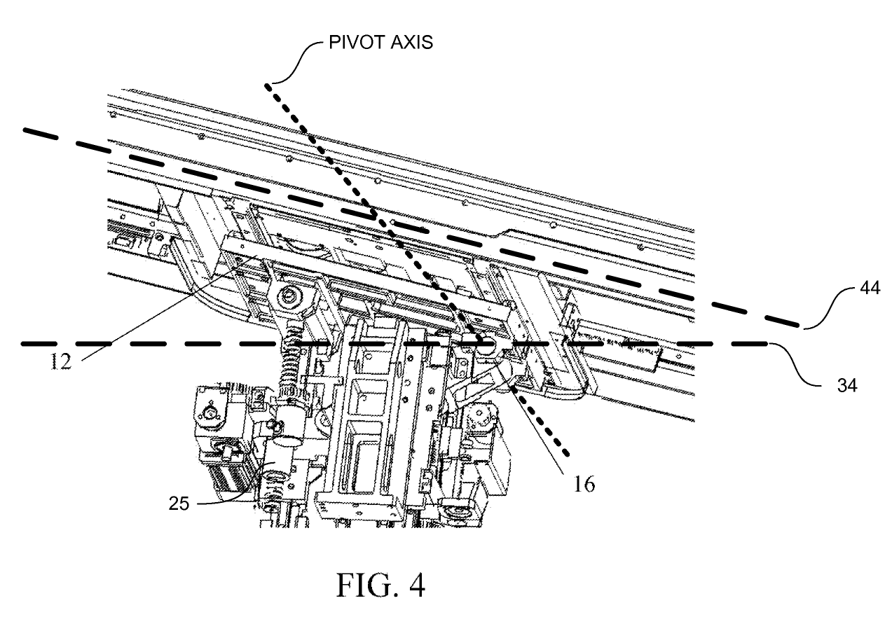

In an embodiment, the patient bed 100 includes at least one of a patient support surface 10 for supporting a patient for examination, a longitudinal plate 11 rigidly coupled to the patient support surface 10 from the underside of the patient support surface 10, and a tilt plate 12 (see FIG. 4) supporting the longitudinal plate 11.

In an embodiment, (see FIG. 4) the tilt plate 12 is mounted on to the base 6 through a hinge 16. A tilt drive 20 (see FIG. 2) is mounted on the longitudinal plate 11 such that when the tilt drive 20 is actuated, the tilt plate 12 tilts to a predetermined angle about the hinge 16, thereby resulting in tilting movement of the patient support surface 10 relative to the ground surface for convenient patient positioning for examination.

In an embodiment, the tilt drive 20 includes a ball screw mechanism 22 coupled to at least one drive motor 21.

For example, the ball screw mechanism 22 includes a driving member (e.g. nut 25 and a driven member (e.g. lead screw 23), wherein the driving member 25 is coupled to the drive motor 21 and the driven member is coupled to the tilt plate 12. The drive motor 21 drives the driving member 25, which in turn drives the driven member resulting in tilting movement of the tilt plate 12 and in turn the patient bed 100.

It should be noted that the either the nut 25 or the lead screw 23 may be configured as the driving member 25.

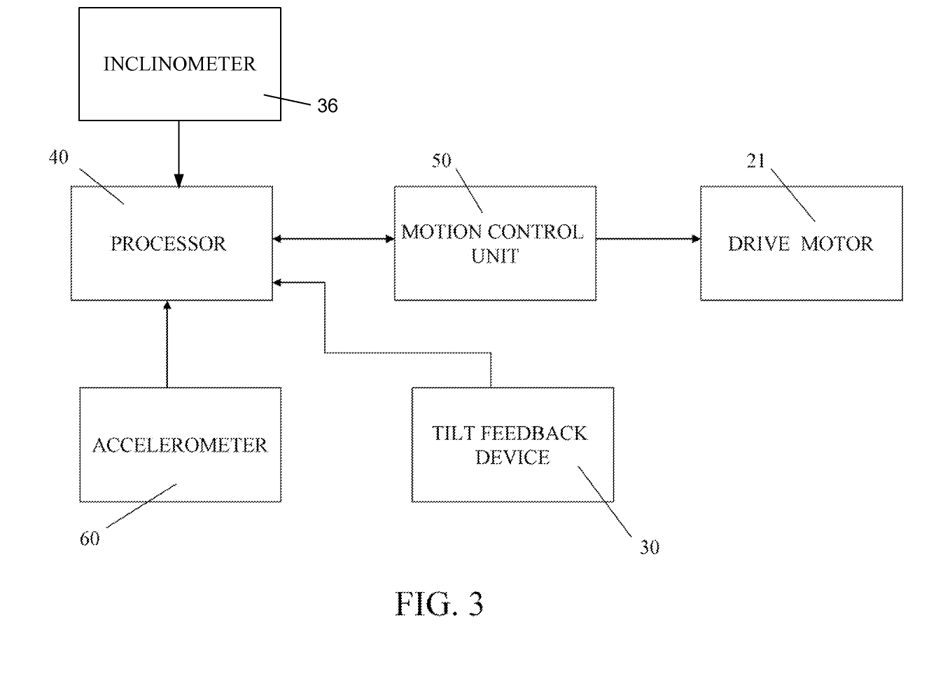

FIG. 3 is a block diagram showing an example of a circuit for tilt calibration, wherein, a tilt feedback device 30 such as, for example, an encoder is coupled to the driving member (e.g. a nut 25) for providing tilt position feedback of the patient bed 100 relative to a home position 34 to a CPU 40. The CPU 40 issues command signal to a motion control unit 50 in response to the output of the feedback device 30. The motion control unit 50 is connected to the drive motor 21 for controlling the tilting movement of the patient bed 100 in response to the command signal from the CPU 40.

The CPU 40 issues a stop command signal when the output of the feedback device 30 indicates a predetermined angular position of the tilt plate 12. For example, the motion control unit 50 stops the tilting movement of the tilt plate 12, on receiving the stop command signal from the CPU 40.

In one example, the encoder is an infinite-turn type absolute position encoder connected to the driving member 25 through a gear mechanism.

Other examples may include an incremental encoder connected to the driving member 25.

In an embodiment, (see FIG. 2) an accelerometer 60 is rigidly mounted (e.g. on the longitudinal plate 11) through a bracket (not shown). The output of the accelerometer 60 indicates the position of the patient bed 100 relative to the ground surface 32. The accelerometer 60 is electrically connected to the CPU 40.

In other embodiments, the accelerometer 60 may also be connected to the motion control unit 50.

In an embodiment, the accelerometer 60 has a Micro Electro Mechanical Systems (MEMS) configuration.

In another embodiment, the accelerometer 60 is a two-axis accelerometer capable of sensing the lateral tilt and the longitudinal tilt of the patient bed 100.

However, in other embodiments, accelerometers 60 such as, three-axis accelerometers may also be implemented depending on the number of tilt axes and the requirement.

It should be noted that the accelerometer 60 is mounted to the longitudinal plate 11 for enabling easy assembly to the patient bed 100. Alternatively, the accelerometer 60 may also be mounted on e.g. the tilt plate 12 or the patient support surface 10, that are tiltably associated with the patient bed 100.

One embodiment is illustrated using the following example:

Table 1 illustrates various positions (tilt angle) of patient bed 100 and the corresponding reading indicated by the tilt accelerometer 60:

TABLE 1

| Table Position (degrees) | Accelerometer Reading (Volt) |
|---|---|
| −15 | 0 |
| 0 | 1 |
| +15 | 2 |

Thus, the formula for calculating the tilt angle is:
Tilt angle=(Accelerometer Reading−1)*15 (1)

For example, the tilt position of the patient bed 100 is determined using an infinite-turn type absolute position encoder with an output of 13 bit per revolution.

At the time of manufacture of the patient support table 1, the feedback device 30 for example, the encoder, the shaft is configured to rotate freely through any angle such that the encoder may not indicate zero reading when the patient bed 100 is at zero degree position (home position 34).

A “home offset” is required to calibrate the encoder shaft and hence the tilt angle of the patient bed 100.

For example, for an encoder rotation of 0 degree, the encoder reading is 1024. For 1 rotation of the encoder, the encoder reading is 8192.

Thus, the formula to calculate the home offset is given by:
Home offset=[(Tilt angle*8192/360)−Encoder reading] (2)

Thus, for zero degree (home position 34) of the encoder shaft (zero tilt of the patient bed), the home offset is given by:
Home offset=(0*8192/360)−1024
Home offset=−1024 encoder counts.

The CPU 40 calculates the “home offset” in response to the output of the encoder and the accelerometer 60. The “home offset” may be stored for later use.

Thus, various embodiments provide a tilt angle calibration system for a medical imaging apparatus. Further embodiments provide a patient support table for a medical imaging apparatus.

While embodiments are described in terms of various specific embodiments, those skilled in the art will recognize that embodiments can be practiced with modifications such as, for example, the patient support table may include an inclinometer 36 configured to indicate the position of the patient bed 100 relative to the ground surface 32. However all such modifications are deemed to have been covered within the spirit and scope of the claims.

1. A tilt calibration system for a positioner having a positioner axis, the tilt calibration system comprising:
at least one first sensor configured to determine the position of the positioner axis relative to ground;
at least one second sensor configured to determine the position of the positioner axis relative to a home position; and
a processor configured to determine a home offset in response to the position of the positioner axis relative to ground and the position of the positioner axis relative to the home position.

2. The tilt calibration system according to claim 1 wherein the first sensor further comprises at least one of an accelerometer and an inclinometer.

3. The tilt calibration system according to claim 1 wherein the first sensor further comprises an accelerometer having a micro electromechanical systems (MEMS) configuration.

4. The tilt calibration system according to claim 1 wherein the second sensor further comprises an encoder.

5. The tilt calibration system according to claim 4 wherein the encoder is at least one of an infinite-turn type absolute position encoder and an incremental encoder.

6. The tilt calibration system according to claim 1 wherein the positioner further comprises:
(i) a patient bed comprising at least one of a tilt plate, a patient support surface and a longitudinal plate, and
(ii) a vascular gantry comprising a c-arm and a pivot axis.

7. The tilt calibration system according to claim 1, wherein the positioner is a vascular positioner and the positioner axis is a vascular positioner axis.

8. A patient support table, comprising:
a patient bed;
a tilt drive coupled to the patient bed;
a tilt position feedback device coupled to the tilt drive;
an accelerometer coupled to the patient bed; and
a processor coupled to the accelerometer and the tilt position feedback devices
wherein the accelerometer is configured to determine the position of the patient bed relative to the ground surface.

9. The patient support table according to claim 8, wherein the tilt position feedback device further comprises an encoder.

10. The patient support table according to claim 9 wherein the encoder is at least one of an infinite-turn type absolute position encoder and an incremental encoder.

11. The patient support table according to claim 8, wherein the tilt drive further comprises:
a drive motor; and
a ball screw mechanism coupled to the drive motor, the ball screw mechanism comprising a driving member and a driven member, wherein the tilt position feedback device is coupled to the driving member.

12. The patient support table according to claim 8, wherein the tilt drive further comprises a drive motor, the drive motor further comprising a motion control unit being configured to control the drive motor in response to a command signal from the processor.

13. The patient support table according to claim 8, wherein the accelerometer further comprises a Micro Electro Mechanical Systems (MEMS) configuration.

14. The patient support table according to claim 8, wherein the patient bed further comprises a longitudinal plate, and wherein the accelerometer is mounted to the longitudinal plate.

15. The patient support table according to claim 14, wherein the processor calculates a home offset in response to output of the tilt position feedback device and the accelerometer.

16. A patient support table, comprising:
a patient bed;
a first unit configured to determine the position of the patient bed relative to a ground surface;
a second unit configured to determine the position of the patient bed relative to a home position; and
a processor configured to determine a home offset in response to the position of the patient bed relative to the ground surface and the position of the patient bed relative to the home position.

17. The patient support table according to claim 16, wherein the first unit further comprises at least one of an accelerometer and an inclinometer.

18. The patient support table according to claim 16, wherein the first unit further comprises an accelerometer, the accelerometer further comprising a micro electromechanical systems (MEMS) configuration.

19. The patient support table according to claim 16, wherein the second unit further comprises an encoder.

20. The patient support table according to claim 19, wherein the encoder further comprises at least one of an infinite-turn type absolute position encoder and an incremental encoder.
